(19) United States
(12) Patent Application Publication
(10) Pub. No.: US 2019/0022831 A1
(43) Pub. Date: Jan. 24, 2019

(54) Ratchet Wrenches

(71) Applicant: Nigel BUCHANAN, By Leven Fife (GB)

(72) Inventor: Nigel BUCHANAN, By Leven Fife (GB)

(21) Appl. No.: 15/773,710

(22) PCT Filed: Nov. 4, 2016
(86) PCT No.: PCT/GB2016/053445

§ 371 Date: May 4, 2018

(30) Foreign Application Priority Data
Nov. 4, 2015 (GB) 1519500.1

(51) Int. Cl. B25B 13/46; B25B 13/04

(52) U.S. Cl. CPC B25B 13/462; B25B 13/04

(57) ABSTRACT

A ratchet wrench (1) is designed such that a clutch ring (500) forms the mid part of an extremely strong laminate like structure. Under torque conditions the compression forces applied to the clutch ring (500) are substantially dissipated around its circumference (507) and inner surface (508), this inward force clamping upon the inherently strong drive outer surface (405). The resultant pseudo laminate like construction of the drive element (400), clutch (500) and housing (201, 202) enables a proportionately stronger ratchet wrench 1 of much reduced depth. The drive element (400) may be used with interchangeable inserts (408).

### FIELD OF THE INVENTION

The invention relates to ratchet wrenches (often referred to in the United Kingdom as spanners) and particularly to pass through ratchet wrenches (pass thru in the US).

### BACKGROUND TO THE INVENTION

Known ratchet wrenches may comprise a wrench head that houses a driven member. The driven member may be provided with an aperture shaped to receive an item that is to be driven. For example, the aperture may be a hexagonal aperture sized to receive a particular size of fastener head/nut. Alternatively, the driven member may comprise a spigot that projects from the wrench head to allow the wrench head to be connected to a drive socket or the like. A resilient annular clutch may be disposed between the wrench head and driven member to transmit an applied torque from the wrench head to the driven member. When the wrench handle is turned in the drive direction to apply a torque to a fastener of the like, the clutch is deformed to lock the wrench head to the driven member to transmit the torque. When the wrench handle is turned in the opposite direction, the clutch springs back to allow relative movement of the wrench head and driven member to all repositioning of the wrench handle.

In order to avoid having an overly large wrench head, the resilient annular clutch may be a relatively thin sprung ring, which when subjected to repeated high torques is deformed to such an extent it becomes ineffective.

The annular clutch may have a series of fine teeth on its outer side to engage correspondingly fine teeth on the wrench head. There may for example be at least one hundred teeth on the annular clutch. Since such teeth are relatively fine, even a small amount of deformation of the annular clutch, for example as little as 0.01% makes it particularly likely to fail properly engage the teeth on the wrench head. Manufacturing a relatively thin annular clutch with fine teeth is not straightforward. One potential manufacturing method is metal injection moulding MIM. MIM parts are moulded from metal particles held together with a percentage of plasticiser or wax. The moulded parts are subjected to a very high temperature in a vacuum oven during which the metal particles fuse and the plasticiser is burnt and vacuumed off. Even differences as small as 0.02% in the process produces variations in the finished size that may cause misalignment of the teeth when the annular clutch ring is forced into engagement with the wrench head.

A further problem with such ratchet wrenches is that the ingress of fine dust or grit quickly fouls the ratchet mechanism.

It is an object of the invention to at least partially alleviate one or more of the above-mentioned problems, or to provide an alternative to existing products. Embodiments of the invention may provide a lower profiled pass through ratchet wrench than any other currently available on the market, whilst attaining or exceeding the current torque standards and in particular enabling a more cost effective and reliable product.

### SUMMARY OF THE INVENTION

The invention provides a ratchet wrench as specified in claim 1.

The invention also includes a ratchet wrench as claimed in claim 17.

The invention also includes a ratchet wrench as claimed in claim 18.

The end of the handle has a biasing profile for interaction with at least one biaser, which may be a spring and ball detent, the biaser acting to provide a direction bias and the initial grip in the required drive direction of the clutch ring upon the drive element. In the rest position of the wrench, the biaser provides a biasing force to provide initial clamping of the clutch ring to obviate any slack or play inherent in normal ratchets.

When the handle is operated in the reverse or reposition direction, the actuator releases its initial or direction biasing force against the abutting clutch actuation face alleviating the biasing springs resilient force partially freeing the clutch inner surface from the drive portion. The action of the drive portion being rotated against any clamping friction of the clutch ring further rotates the clutch outer ramps away from the corresponding housing ramps allowing the clutch ring to expand further, negating the grip of the clutch ring upon the driven member drive surface, usefully allowing the drive portion or shaft to be reversed or repositioned. The magnitude of the clutch engaging spring force is directionally proportionate to that of the detent resilient portion, to that end the clutch ring generally requires to be thin in section and made from resilient material like high grade spring steel. The device is designed such that the clutch ring forms the mid part of an extremely strong laminate like structure, under torque conditions, the resultant compression forces applied to the clutch ring are substantially dissipated around its circumference. The resultant pseudo laminate like construction of the drive, clutch, and housing enables a proportionately far stronger or a thinner lighter device.

The invention may include a ratchet wrench wherein the drive element can usefully have further drive inserts. In one example the drive inner surface could engage and operate say a 19 mm fastener, by the advantageous use of further drive inserts many smaller or larger fastener head sizes and types can be operated utilizing the same ratchet mechanism whilst usefully retaining a low drive portion profile. The inserts in best practice having a sufficient sized through-hole that fasteners operated on say a screwed rod can be usefully operated, the screwed rod protruding through the through-hole during use.

If the outer radiuses of the drive teeth have minimal radius, their locking engagement with the smooth section of the clutch ring will be measurably enhanced.

The size and shape of the housing ramps and clutch transmission ramps may be chosen to ensure that they cannot completely disengage from one another when the ratchet wrench is used in the reverse direction.

In order to achieve utmost drive tooth contact with the inner sidewall of the clutch ring, it is desirable that the innermost circumferential profile of both the toothed section, and smooth section of the clutch sidewall are identical. To that end, the clutch's inner smooth section profile is substantially the same as the inner height of the teeth of the toothed section, a further aid being the tops of the outer toothed wall of the drive portion are preferably radiused or near flat topped, the “flat top” being substantially the same circumferential profile as the inner sidewall of the clutch's smooth section.

If the outer tips of the drive teeth have a minimal radius, their locking engagement with the smooth section of the clutch inner sidewall will be measurably enhanced.

The operating angle of the housing ramps and the clutch transmission ramps may be between eight and thirty degrees.

Having a partially toothed engagement portion between the clutch inner surface and the toothed outer surface of the drive element may substantially reduce the problem of the clutch ring elongation and the problem of tooth mismatch due to manufacturing difficulties, thereby reducing the manufacturing and warranty costs.

The parts of the wrench head may be constructed in a quasi-laminate manner. This structure may provide an inherently stronger mechanism, thus permitting superior torque and useful head size reduction. Laminates are inherently stronger than similar thickness materials due to the utilisation of using metal grain structures in dissimilar grain directions (cross grain).

A match between the clutch toothed portion, and the clutch smooth portion profiles as they mesh with the drive toothed profile when operated in the drive direction ensures a pseudo laminate-like construction. The housing ramps also match the transmission ramps in a similar manner. The drive ramps may equalise the compression and stresses imparted upon the clutch ring and drive element in an inward direction i.e. compression in the drive direction. When the wrench is operated in the reverse or reposition direction, the clutch transmission ramps move down the housing ramps within the confines of the housing ramp walls and the clutch transmission ramp shoulders which limit the closing of the gap created when they abut. This permits clutch ring expansion into the gap, which provides delamination during the reverse action allowing the now lightly engaged clutch toothed portion to effortlessly traverse the drive teeth.

Embodiments of the invention allow the housing depth to be reduced, allowing the operation of the ratchet in situations unavailable to other prior art ratchet wrenches, whilst still passing the relevant torque standards.

When the wrench head is at rest, the clutch toothed portion is already biased into the corresponding drive teeth by the at least one biaser in order to provide as far as possible instantaneous engagement or meshing with the drive teeth when the wrench head is turned in the drive direction.

The housing enclosure strength may be enhanced by the use of protrusions and recesses placed strategically around the housing aperture. The protrusions or their corresponding recesses can be on either housing face, fitting snugly into one another they provide the housing with the ability to be substantially reduced in profile yet retain strength and robustness.

The housing strength may be enhanced by the fact that the main locking forces are directed inwards upon the extremely strong drive element circumference, further reducing the need for thick housing walls.

The housing may comprise top and bottom housing portions secured against one another by a snap ring type retainer within a retaining clip channel within the drive element. The drive element may have a retaining flange. Alternatively, or additionally, the top and bottom housings may be secured to one another by rivet upstands incorporated within the top or bottom housing portions, the opposing housing portion having a countersunk hole for the retention of the rivet head profile. By incorporating the rivet fixing within the housing moulding and thereby virtually obviating the chance of a separate rivet or screw coming loose from the head portion the device is ideal for use in the aerospace industry as the incidence of foreign objects being left in problem areas is further reduced.

The top and bottom housings can be produced as mirror copies of one another to reduce costs and inventory. One housing portion may have housing closure holes and the other mating housing closure protrusions. The manufacturing method in one example may be by precision metal injection moulding MIM. The fixings could be rivets within countersunk holes, the rivets having centre holes for the ease of precision splaying.

The housing may comprise the top and bottom housing portion and these and the clutch ring and drive element may be produced by metal injection moulding MIM. This process allows the parts to be mass produced in great numbers with great precision. The drive teeth can easily be over 120 in number whilst the profiles of the teeth remain accurate.

In order to further reduce the overall working depth of the wrench head, the depth of the inserts can be of a reduced height compared to known inserts. The use of reduced height square drive inserts with compatible low profile sockets would greatly increase capability of the ratchet wrench to work in restricted access areas.

The housing depth for a ¼ inch square drive may be less than 8 mm.

The housing depth for a ¼ inch square drive may be less than 7 mm.

The housing depth for a ¼ inch square drive may be less than 6 mm.

The housing depth for a ⅜ inch square drive may be less than 11 mm.

The housing depth for a ⅜ inch square drive may be less than 10 mm.

The housing depth for a ⅜ inch square drive may be less than 9 mm.

The housing depth for a ⅜ inch square drive may be less than 8 mm.

The housing depth for a ½ inch square drive may be less than 12 mm.

The housing depth for a ½ inch square drive may be less than 11 mm.

The housing depth for a ½ inch square drive may be less than 10 mm.

### BRIEF DESCRIPTION OF THE DRAWINGS

In order that the invention may be well understood, some embodiments, which are given by way of example only, will now be described with reference to the drawings, in which:

FIG. 1 is a perspective view of the compact ratchet wrench;

FIG. 2 is a perspective view of the ratchet wrench with a switch;

FIG. 3 is an exploded perspective view of the ratchet wrench of FIG. 1;

FIG. 4 is an exploded perspective view of the ratchet wrench of FIG. 2;

FIG. 5 is a top view of the ratchet wrench of FIG. 1

FIG. 6 is an enlargement of the circle portion in FIG. 5;

FIG. 7 is an enlargement of the ratchet wrench of FIG. 1 with a handle end engaging a clutch ring;

FIG. 8 is a top view of the ratchet wrench of FIG. 2;

FIG. 9 is an enlargement of the circled portion in FIG. 8;

FIG. 10 is a perspective view of a drive element for the ratchet wrench of FIG. 1;

FIG. 11 is a perspective view of a drive element for the ratchet wrench of FIG. 2;

FIG. 12 is a perspective view of a clutch ring of the ratchet wrenches of FIGS. 1 and 2;

FIG. 13 is a top view of a portion of another ratchet wrench;

FIG. 14 is a top view of yet another ratchet wrench;

FIG. 15 is a part sectioned enlargement of a switch of the ratchet wrench of FIG. 14;

FIG. 16 is an enlargement of the ratchet wrenches showing a clutch ring engaging a drive element; and

FIG. 17 is a perspective view of the ratchet wrench of FIG. 1 fitted with a drive insert shown engaging a fastener.

### DETAILED DESCRIPTION

The drawings are not necessarily to scale and, some features may be exaggerated to show details of particular components. Therefore, specific structural and functional details disclosed herein are not to be interpreted as being limiting, but merely as a basis for the claims.

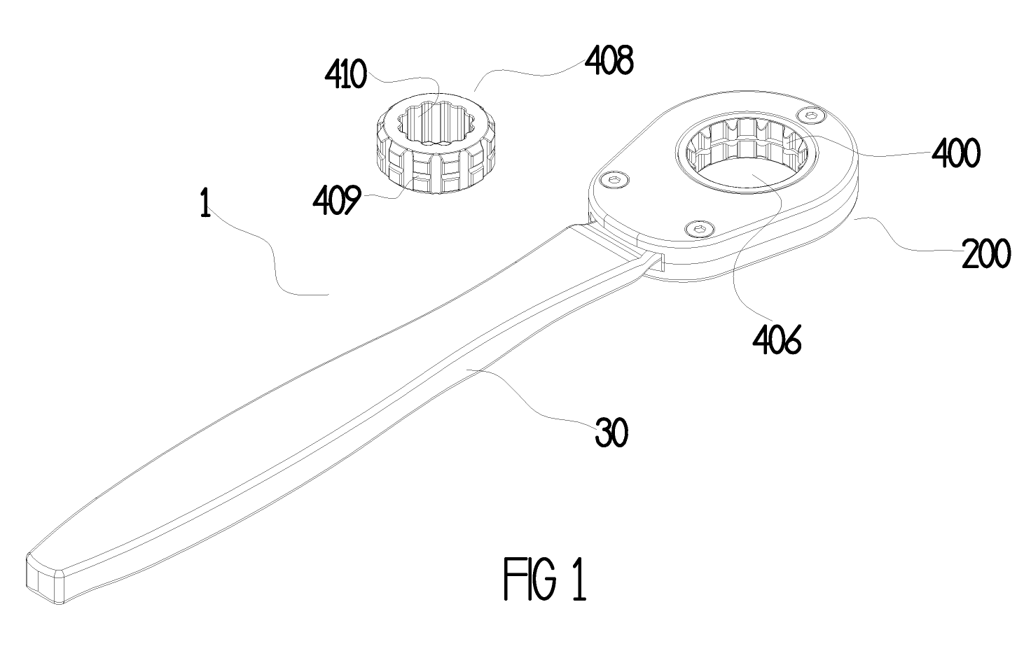

FIG. 1 illustrates an embodiment of a pass through ratchet wrench 1, denoting a handle 30 at one end and a housing 200 with a drive element 400 with its drive aperture 406 at the other end. A drive insert 408 with its engaging means 409 and fastener engaging means 410 shown separate from the ratchet wrench 1, the ratchet wrench 1 is at rest.

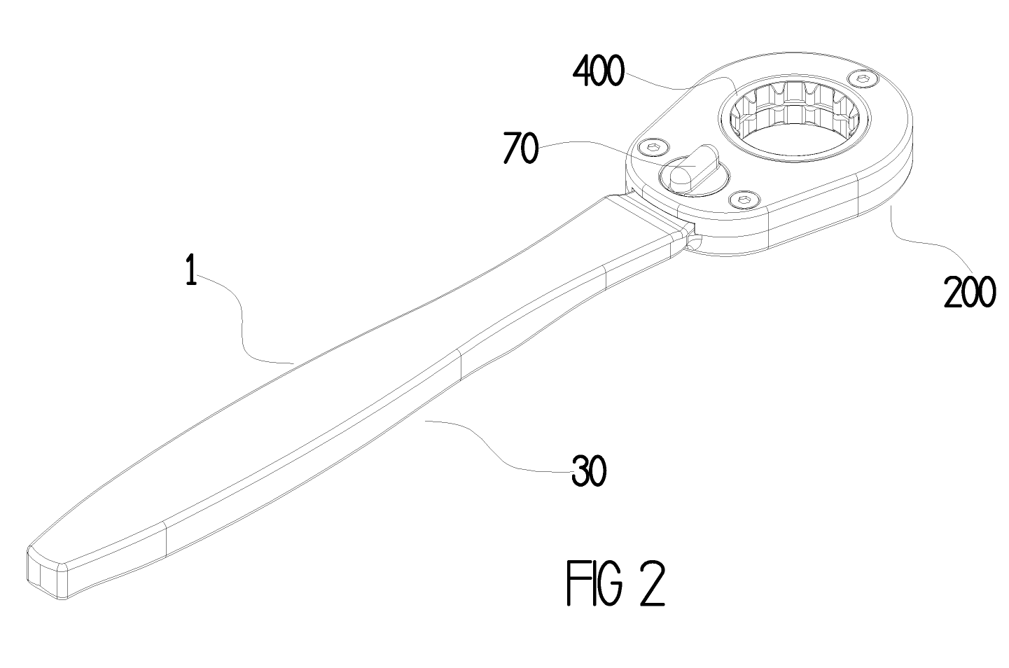

FIG. 2 illustrates a further embodiment of a said pass through ratchet wrench 1 wherein the drive direction D is effected by a switch 70, denoting the said handle 30 at one end and the housing 200 with a said central drive element 400 at the other end. The ratchet wrench 1 is shown is at rest.

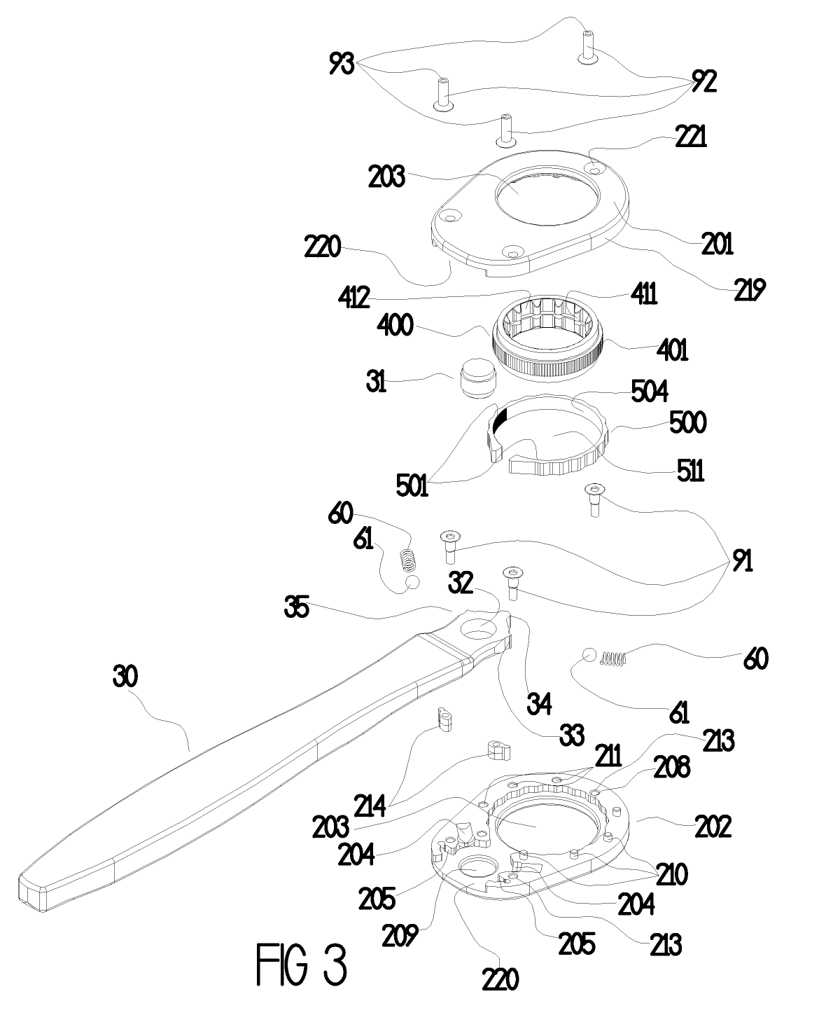

FIG. 3 is a perspective view of the pass through ratchet wrench 1, the parts shown dismantled for display purposes. The top housing 201, bottom housing 202, housing aperture 203, spring and ball channel 204, dust seal channel 205, housing inner surface 208, pivot pin recess 209, housing closure protrusion 210, housing closure holes 211, housing closure holes 211, housing fixing holes 213, housing dust seals 214, housing outer surface 219, housing opening 220 and housing countersunk holes 221. The said handle 30, handle pivot pin 31, handle pivot bore 32, biasing protrusion 33, actuator 34 and levered end 35. The drive element 400, drive teeth 401, drive engaging member 411 and drive inner surface 412. Clutch ring 500, clutch toothed portion 501, clutch smooth portion 504 and clutch aperture 511. The spring 60, ball 61, screw fixings 91 and alternative rivet fixing 92 with their centre holes 93 are further shown.

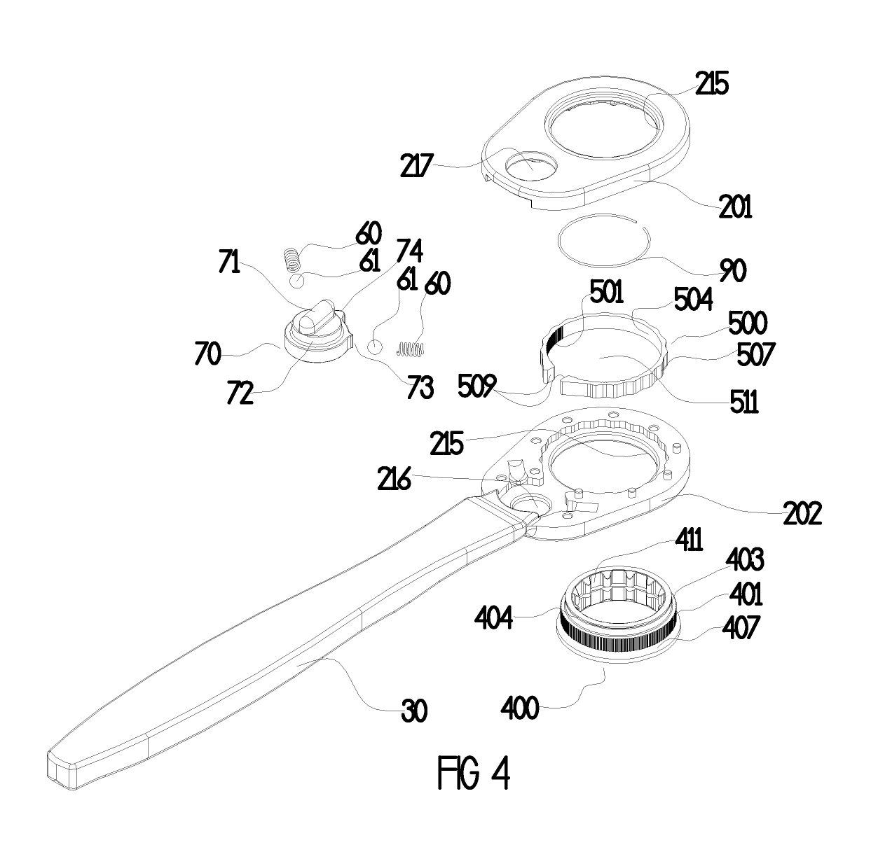

FIG. 4 illustrates a further embodiment of a said pass through ratchet wrench 1 wherein the drive direction D is effected by a said switch 70. The said bottom housing 202 is directly attached to the said handle 30, the said top housing 201 being secured by a retaining clip 90 within the drive retaining clip channel 404, the parts are shown dismantled for display purposes. The said drive 400 having a retaining flange 407, said teeth 401, drive axle 403 and said engaging member 411. The said clutch ring 500, said toothed portion 501, said smooth portion 504, outer surface 507 and clutch aperture 511. The said top and bottom housing 201, 202 having a drive flange recess 215. The said top housing 201 having a further switch axle bore 217 and the said bottom housing 202 having an adjoining housing switch axle recess 216. The said switch 70 having switch axles 72, biasing protrusions 73, actuator 74 and finger grip 71. In use the switch 70 is operated in the required direction, the said biasing protrusions 73 acting with the said springs and balls 60, 61 to resiliently urge the switch actuator 74 against the corresponding clutch actuation face 509.

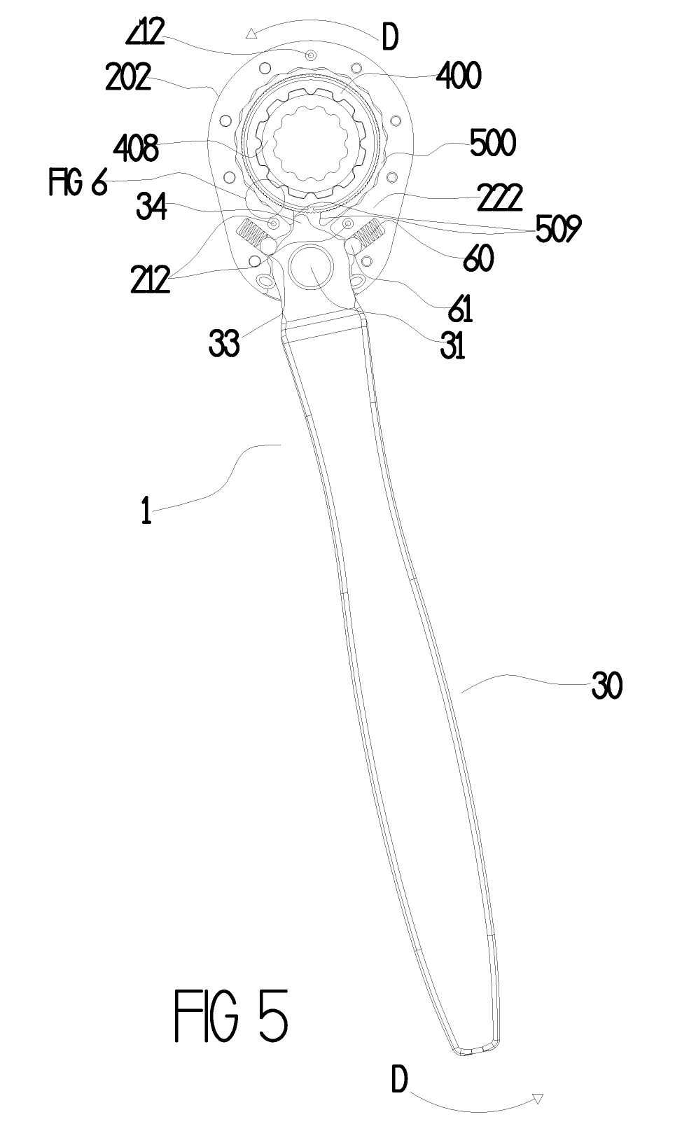

FIG. 5 illustrates the pass through ratchet wrench 1 operated in the drive direction D, the said top housing 201 (not shown) removed showing the said bottom housing 202 inner face 222. The handle 30 swivelled in the required said drive direction D around the said pivot pin 31, the resilient action of the said spring and balls 60, 61 upon the said biasing protrusions 33 urging the said actuator 34 against the said clutch actuation face 509. The said drive element 400 is shown within the said clutch ring 500 and a said drive insert 408 within the said drive element 400. The closure of the said top and bottom 201,202 housings is attained by the illustrated rivet upstands 212.

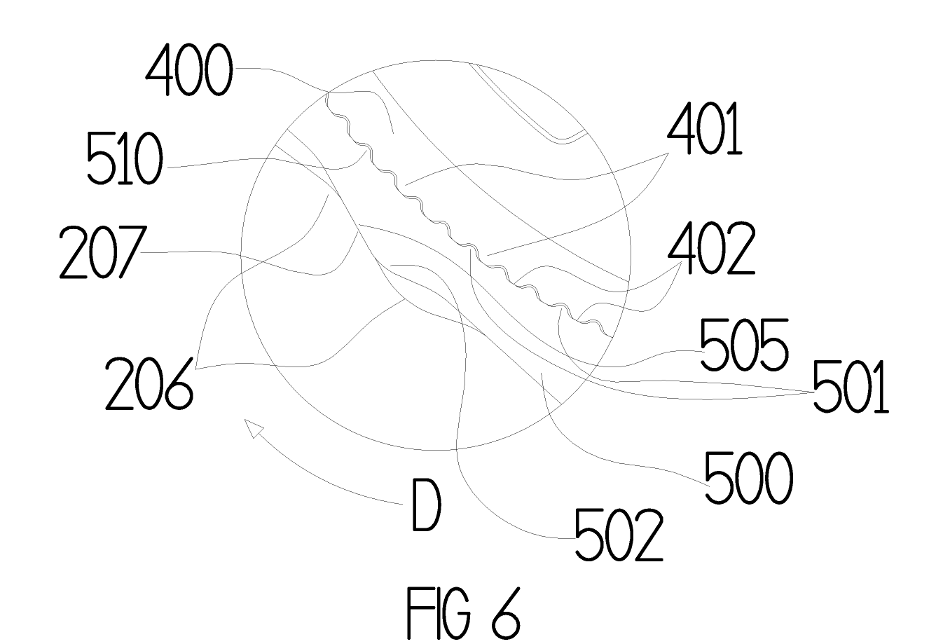

FIG. 6 is a close up view of the said pass through ratchet wrench 1 clutch toothed portion 501 teeth 510 engaged within corresponding drive teeth 401, the said drive teeth 401 having flat tops 402. The said clutch rings 500 engagement with the said drive element 400 robustly enhanced by the inward projection of the said clutch ring 500 as the clutch transmission ramps 502 and abutment angles 505 abutting the housing ramps 206 and contact angles 207 are driven upwards against one another as the said ratchet 1 is operated in the drive direction D.

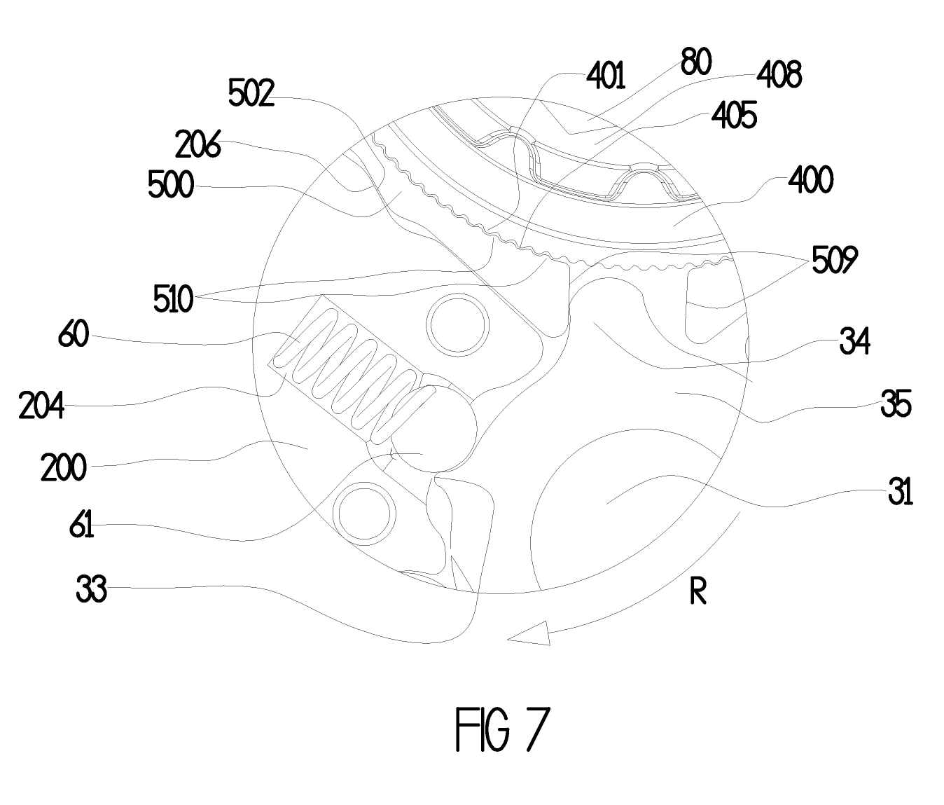

FIG. 7 is a close up view of the said pass through ratchet mechanism 1 said housing 200, the said top housing 201 removed (not shown). The handle levered end 35 and said head portion 200 rotating as required around the said handle pivot pin 31, operated in the reverse or reposition direction R, the said handle protrusions 33 causing the said springs and balls 60,61 to be resiliently propelled back up the said spring and ball channel 204 thereby causing the said actuator 34 to reduce or release its pressure against the said clutch actuation face 509, the said clutch transmission ramps 502 no longer abutting the corresponding said housing ramps 206 thereby disengaging the clutch teeth 510 from the drive outer surface 405 and allowing the said head portion 200 to rotate relative to the said drive element 400, said drive insert 408 and its operated fastener 80.

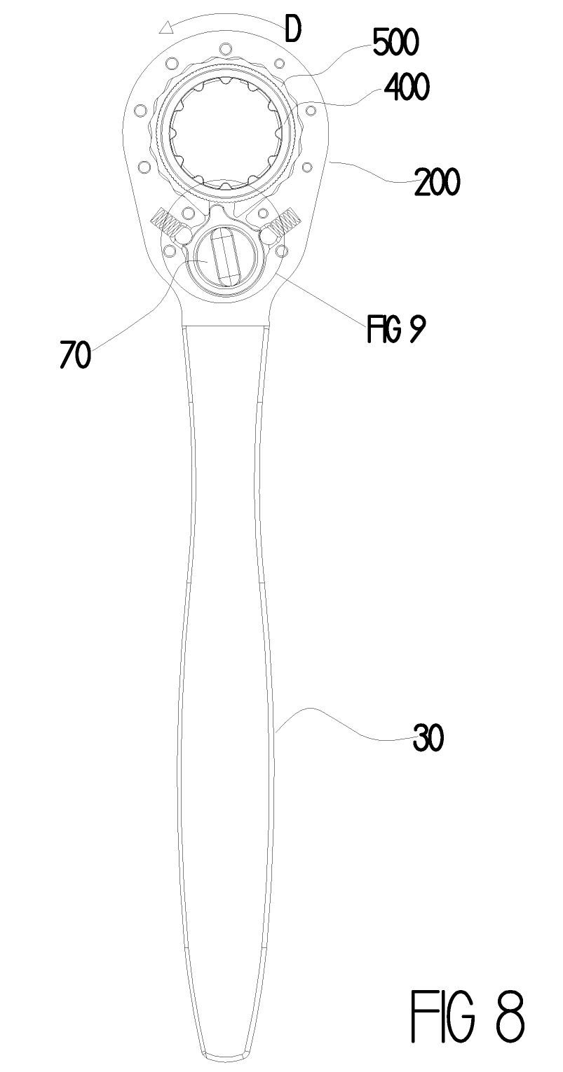

FIG. 8 is a top view of a switch 70 version of the said ratchet wrench 1, the top housing 201 removed. The said housing 200 is directly attached to the said handle 30, the said clutch ring 500 and said drive element 400 are also shown.

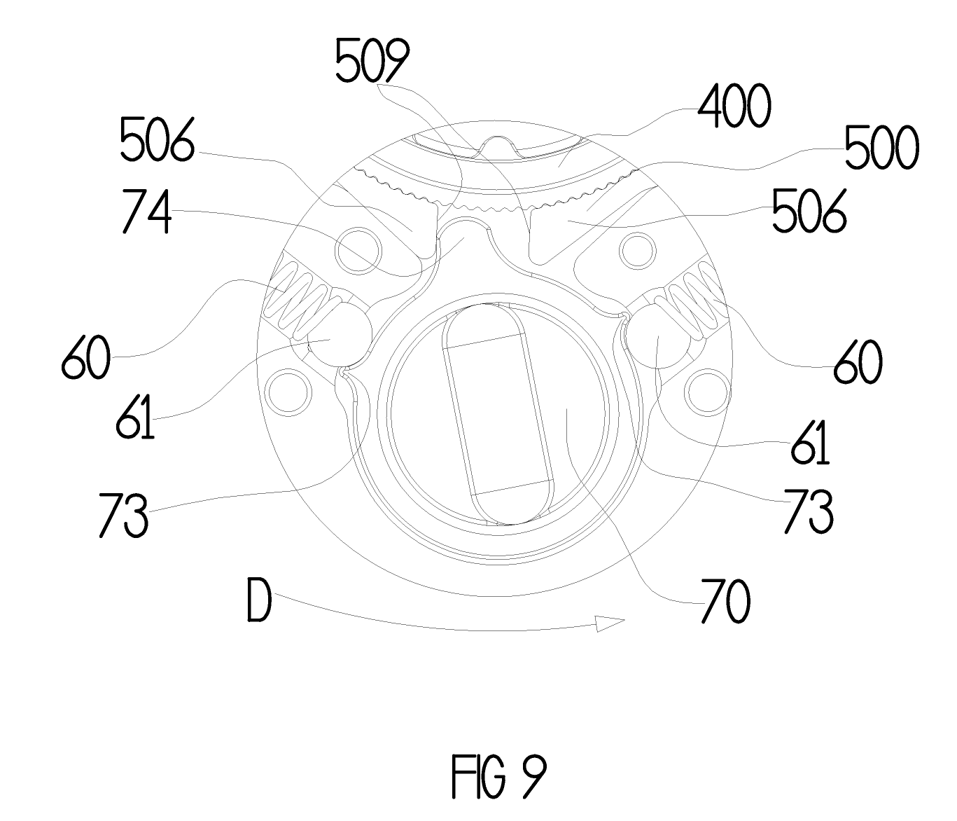

FIG. 9 is a close up view of the switch 70 version of the said pass through ratchet wrench 1 denoting the said switch 70 with its said biasing protrusions 73 and its actuators 74 interaction with the clutch actuation faces 509. The spring and balls 60, 61 providing the biasing of the clutch ring 500 in the required drive direction D. The biasing spring 60 resilient force being transmitted via the switch biasing protrusion 73 then said actuator 74 to the said clutch actuation face 509 within the tail portion 506.

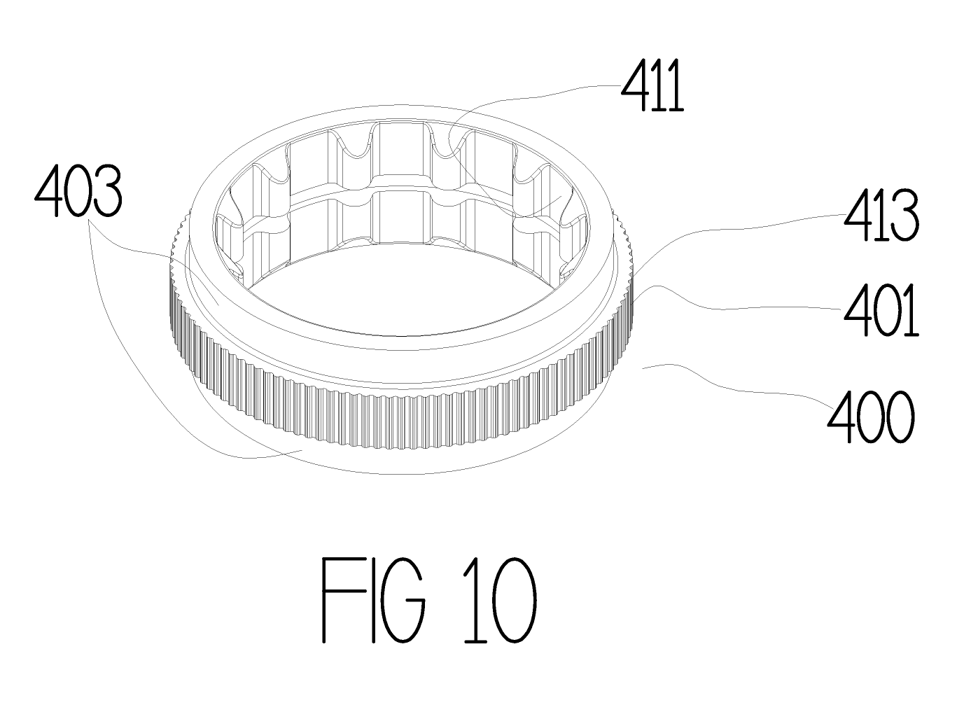

FIG. 10 is the drive element 400 showing the drive teeth 401 within the drive outer surface 413, drive axles 403 and said drive engaging member 411.

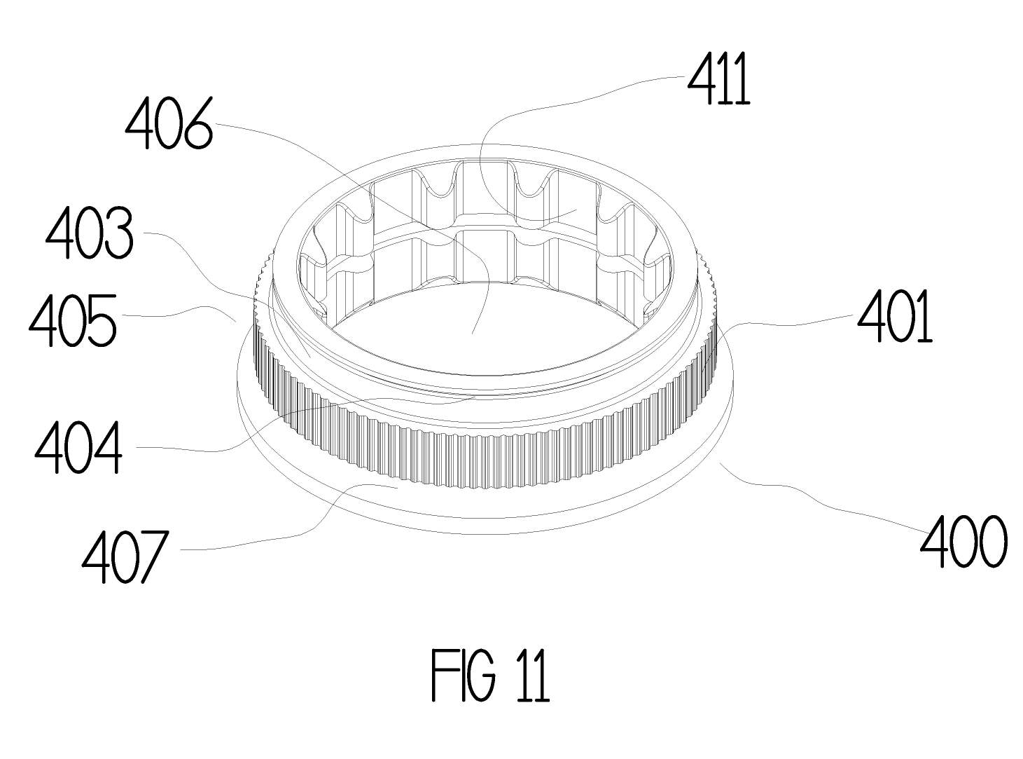

FIG. 11 is a further iteration of the said drive element 400 complete with a retaining flange 407, comprising said drive teeth 401, said drive axle 403, said retaining clip channel 404, drive outer surface 405, said drive aperture 406 and said drive engaging member 411.

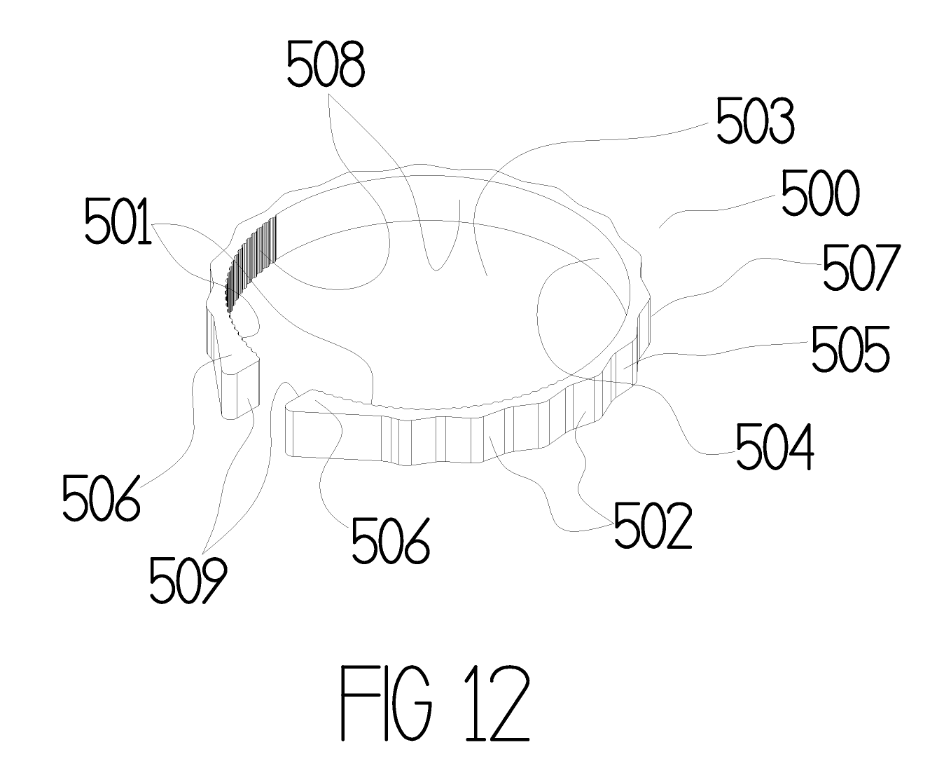

FIG. 12 is the said clutch ring 500 comprising, a said toothed portion 501, said transmission ramps 502, aperture 503, said smooth portion 504, said abutment angle 505, tail portion 506, said outer surface 507, inner surface 508 and said actuation faces 509.

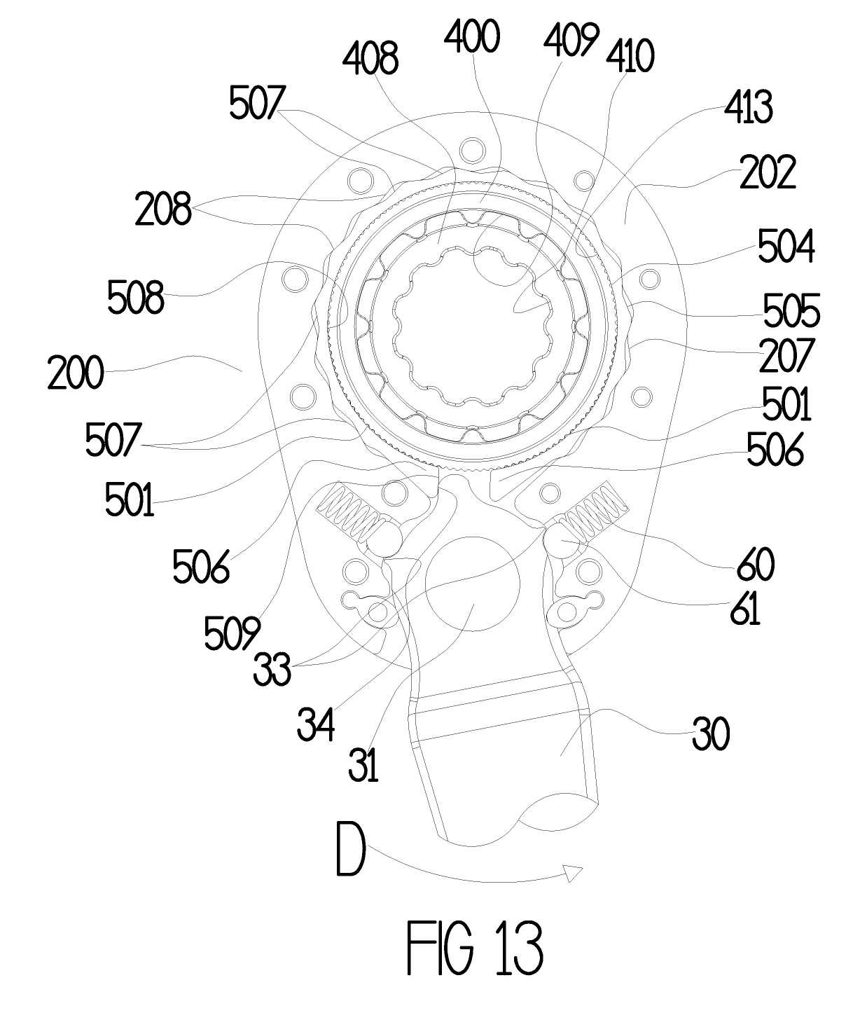

FIG. 13 is a top view of the said pass through ratchet wrench 1, said housing 200, the said top housing 201 removed (not shown). The handle 30 and said head portion 200 rotating as required around the said handle pivot pin 31, operated in the said drive direction D, the said springs and balls 60,61 resiliently acting on the said handle protrusions 33 causing the said actuator 34 to resiliently act against the said clutch actuation face 509 thereby urging the said clutch toothed portion 501 in best practice affixed the said clutch tail portion 506 to engage the said corresponding drive element teeth 401. This initial grip further allows the said clutch ramp abutment angle 505 to act upon the said housing ramps contact angle 207 forcefully constricting the said clutch ring 500 said toothed 501 and smooth portions 504 upon the said drive element 400. The compression and locking force increasing according to the torque applied to the said handle 30. It can be observed from the illustration that during use in the said drive direction D that the housing inner surface 208 is in equal force contact with most of the said clutch outer surface 507 and the said clutch inner surface 508 is in equal force contact upon the majority of the drive outer surface 413 thereby substantially distributing the inward and outward forces evident within the said housing 200 within the circumference of the aforementioned parts. The said drive insert 408, said drive engaging means 409 and said fastener engaging means 410 are further shown.

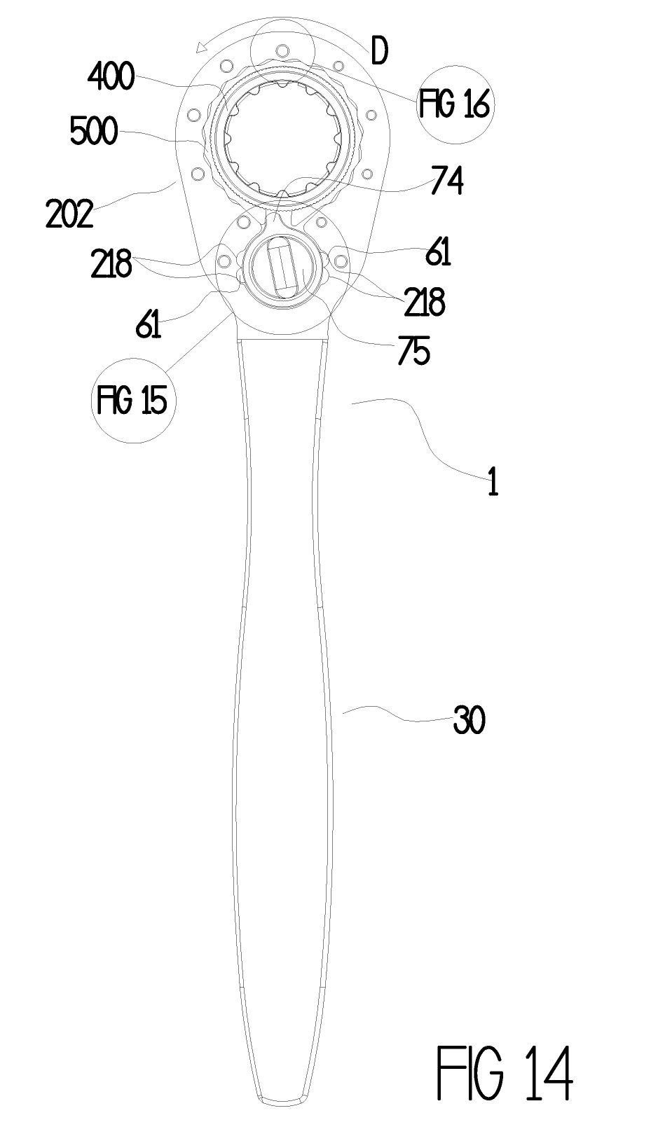

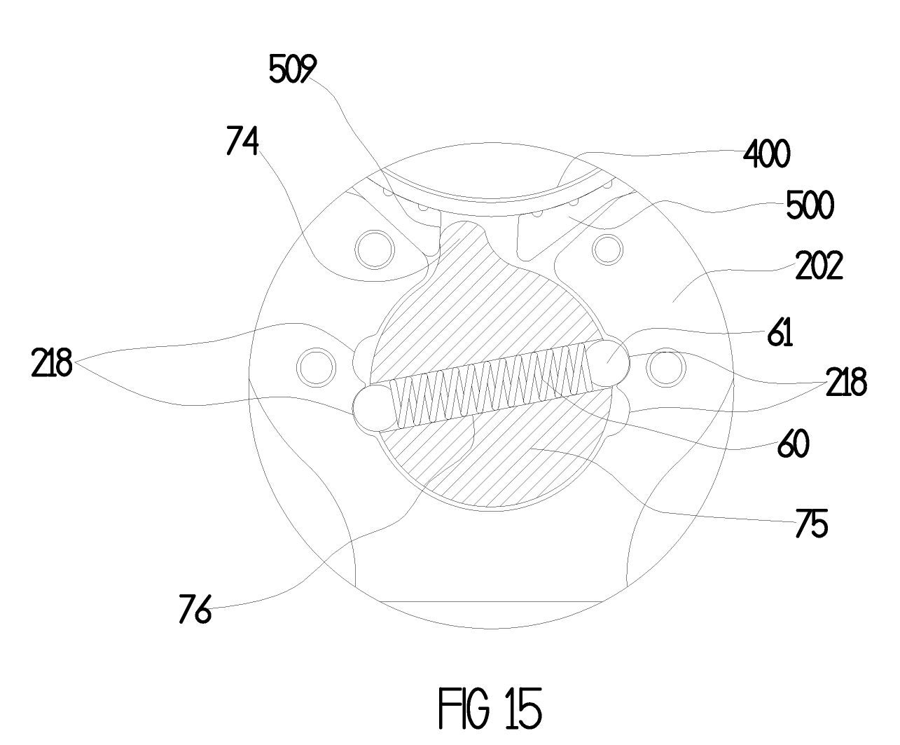

FIGS. 14 and 15 (in section) shows an alternative switched 75 version of the pass through ratchet wrench 1, the said top housing 201 removed (not shown), the said bottom housing 202 affixed the said handle 30. The alternative switch 75 having a spring bore 76 retaining the said spring 60 and balls 61. The said balls 61 acting against the alternate biasing profile 218 in order to impose the required resilient pressure in the desired drive direction D from the said switch actuator 74 to the said clutch actuation face 509 in order to resiliently initially engage the said clutch ring 500 upon the said drive element 400.

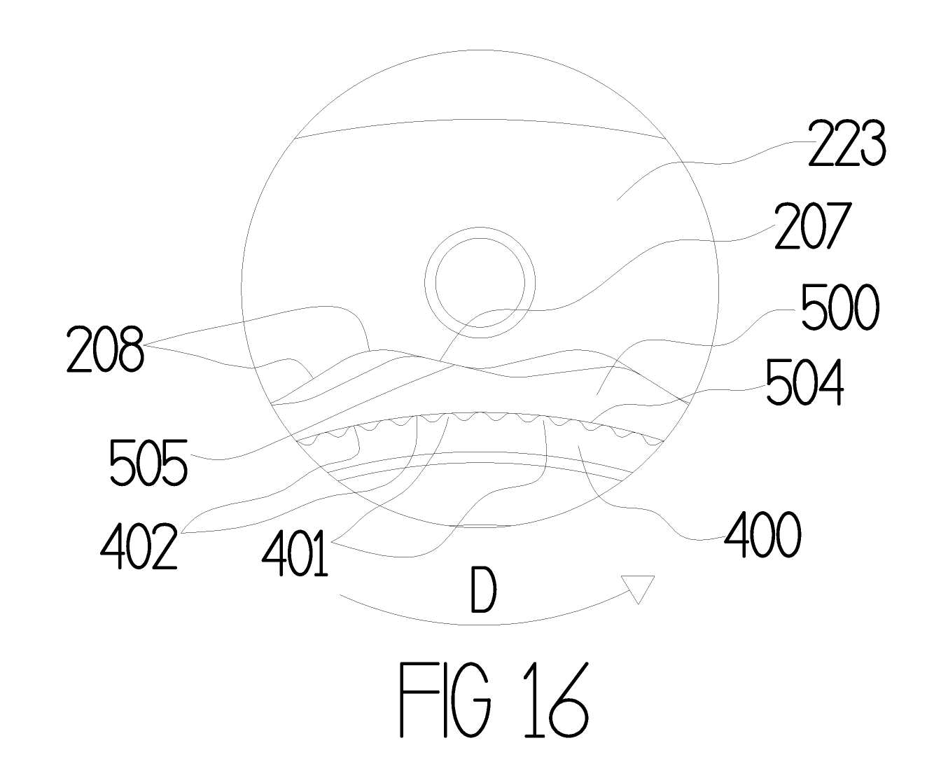

FIG. 16 is a close up view of the pass through ratchet wrench 1 said bottom inner housing face 223. Said clutch ring 500 said inner smooth portion 504 gripping upon the said drive teeth 401 said flat tops 402. The said clutch ramp abutment angles 505 and said housing ramps contact angles 207 are shown engaged as they would be in the said drive direction D providing the desired locking pressure between the housing inner surface 208, said clutch ring 500 and the said drive element 400.

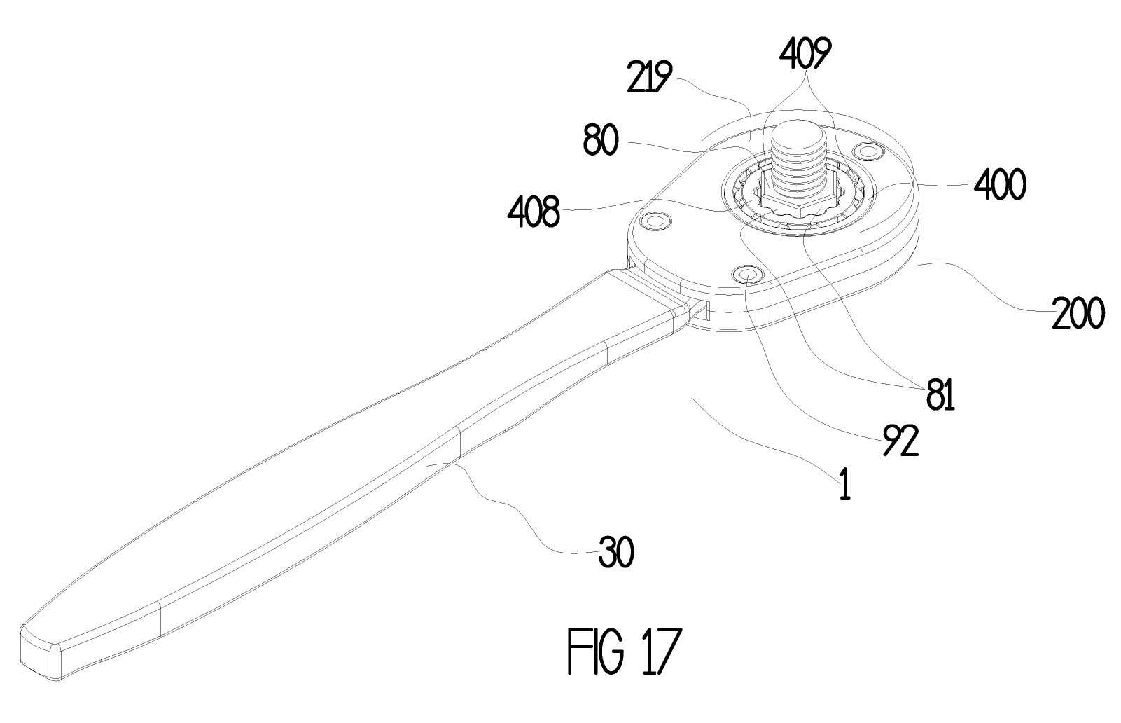

FIG. 17 illustrates the said ratchet wrench 1, the handle 30, housing 200 with a drive insert 408 within the drive element 400. A further appropriately sized fastener 80 is shown, the fastener drive surfaces 81 engaged by the said drive insert engaging means 409. The housing outer surface 219 is shown secured by said rivet fixings 92.

FIGS. 1 to 17 illustrate various examples of the ratchet wrench 1 wherein the levered end 35 of the handle 30 has, in one iteration, biasing protrusions 33 for interaction with at least one spring 60 and ball detents 61, the sprung detent 60, 61 acting to provide a direction bias and the initial grip in the required said drive direction D of the clutch ring 500 upon the central drive 400. In the ratchet wrenches rest position, the partially compressed springs 60 transmit their resilient force via the said detent balls 61 and the actuator 34 to the clutch ring 500 in order to provide the necessary initial clamping of the clutch ring 500 and to obviate any slack or play inherent in normal ratchets.

The clutch portion 500 having a said generally smooth inner surface 504 with in best practice a said toothed 501 tail portion 506 and a said outer surface 507 with said ramp like protrusions 502 corresponding to said like ramps 206 within the said inner surface of the housing 208. When the said handle or drive shaft 30 is further operated in the said drive or locking direction D the said partially toothed 501 and smooth 504 inner surface 508 of the said clutch 500 having initially resiliently clamped the corresponding said toothed 401 profile of the said circumferential surface 405 of the said driven member 400 in order that when additional torque is applied in the said drive direction D to the said handle 30 or drive shaft (not shown) the said clutch portion 500 is further urged inwards as the said clutch ramp protrusions 502 usefully engage the corresponding said inner housing ramps 206, further propelling the said inner surface 508 of the said clutch ring 500 inwards upon the said outer surface 405 of the said central drive portion 400 and if required its said drive insert 408 enabling the said engaged fastener 80 to be robustly driven. In order to optimise the said clutch 500 initial said inner surface 508 grip upon the corresponding said drive portion 400 said outer circumference 405 the said toothed portion 501 of the said clutch 500 has said teeth 510 which interlock with the similar pitch and profile of the said drive teeth 401.

Operating the handle 30 in said reverse or reposition direction R the said actuator 34 releases its initial or direction biasing force clamping the said clutch inner surface 508 upon the said drive element circumference 405 provided by the said detent resilient portion 60,61 acting to free the said clutch ring 500 from the said drive portion outer circumference 405. The action of the said drive portion 400 being rotated against the clamping friction of the said clutch ring 500 further rotates the said clutch outer ramps 502 away from the said corresponding housing ramps 206 allowing the said clutch ring 500 to expand negating the grip of the said clutch ring 500 upon the said driven member drive surface 405 usefully allowing the said drive portion 400 to be said reversed or repositioned R. The magnitude of the clutch 500 engaging spring force is directionally proportionate to that of the detent resilient portion 60, to that end the clutch ring 500 generally requires to be thin in section and made from resilient material like high grade spring steel. The ratchet wrench 1 is designed such that the said clutch ring 500 forms the mid part of an extremely strong laminate like structure, under torque conditions the resultant compression forces applied to the said clutch ring 500 are substantially dissipated around its said circumference 507. The resultant pseudo laminate like construction of the said drive 400, clutch 500 and housing 201, 202 enables a proportionately far stronger or alternately a thinner lighter device.

The invention expressly comprises a “pass thru” ratchet wrench 1 wherein the said drive element 400 can have further drive inserts 408 fitted. In one example the said drive inner surface 412 could engage and operate say a 19 mm fastener, by the advantageous use of further said drive inserts 408 many said further fastener head sizes 410 and types can be operated utilising the same said ratchet wrench 1 whilst usefully retaining a low said housing 200 profile.

1. A ratchet wrench comprising:
a wrench head comprising a housing having a through-hole defined by a sidewall provided with a plurality of housing ramps;
a clutch ring disposed in said through-hole, said clutch ring having first and second ends each having an actuator face, an outer circumferential surface provided with a plurality of clutch transmission ramps to engage with said housing ramps and inner circumferential surface, at least a portion of said inner circumferential surface being provided with a plurality of clutch teeth;
a handle having a first end received in said wrench head, said first end being provided with an actuator disposed in said through-hole between said actuator faces and at least one protrusion engageable with a biaser disposed in said wrench head; and
a drive element biasing disposed in said clutch ring, said drive element having an outer surface comprising a plurality of drive teeth to engage said clutch teeth and a drive aperture configured to engage a workpiece to be driven by the ratchet wrench.

2. A ratchet wrench as claimed in claim 1, wherein said inner circumferential surface of said clutch ring has a plurality of said clutch teeth at said first end and a smooth surface portion between said clutch teeth and said second end.

3. A ratchet wrench as claimed in claim 1, wherein said actuator has a first position and a second position, in said first position a first said biaser engages a first said biasing protrusion to cause said actuator to act on said actuator face of said first end of said clutch ring to pre-bias said transmission ramps against said housing ramps so that the wrench head is configured to apply a drive torque to said workpiece in a clockwise direction and to permit reverse rotation of said housing relative to said drive element in an anticlockwise direction, and in said second position a second said biaser engages a second said biasing protrusion to cause said actuator to act on said actuator face of said second end of said clutch ring to pre-bias said transmission ramps against said housing ramps so that said wrench head is configured to apply a drive torque to said workpiece in an anticlockwise direction and permit reverse rotation of said housing relative to said drive element in a clockwise direction.

4. A ratchet wrench as claimed in claim 3, wherein in said drive torque applying directions said clutch teeth initially engage said drive teeth thereby causing said clutch transmission ramps to move up along said housing ramps to cause consistent compression of said clutch ring against said drive element.

5. A ratchet wrench as claimed in claim 5, wherein said clutch transmission ramps move down along said housing ramps to allow said clutch to expand, thereby causing said clutch teeth to disengage said drive to permit said reverse rotation.

6. A ratchet wrench as claimed in claim 3, wherein said wrench at least one biaser comprises a ball and a spring acting on said ball.

7. A ratchet wrench as claimed in claim 3, wherein said first and second biasers and the first and second biasing protrusions are configured to selectively retain said actuator in said first and second positions.

8. A ratchet wrench as claimed in claim 1, wherein said housing ramps are disposed parallel to respective facing said clutch transmission ramps for complementary engagement by relative sliding movement.

9. A ratchet wrench as claimed in claim 1, wherein said housing is comprises a top housing portion and a bottom housing portion and each of said top and bottom housing portions has housing closure protrusions and housing closure holes which interlock when said top and bottom housing portions are assembled.

10. A ratchet wrench as claimed in any claim 1, wherein said housing is provided with a seal channel and at least one seal situated within said seal channel.

11. A ratchet wrench as claimed in claim 1, wherein said housing ramps have a length in a circumferential direction of said drive element, said clutch transmission ramps have a length in said circumferential direction and said housing ramps and said clutch transmission ramps have a common ramp angle in said circumferential direction that is in the range eight to thirty degrees.

12. A ratchet wrench as claimed in claim 1, having at least 40 drive teeth.

13. A ratchet wrench as claimed in claim 1, having at least 120 drive teeth.

14. A ratchet wrench as claimed in claim 1, having a ¼ inch square drive and said housing having a depth of less than 8 mm.

15. A ratchet wrench as claimed in claim 1, having a ⅜ inch square drive and said housing having a depth of less than 9 mm.

16. A ratchet wrench as claimed in claim 1, having a ½ inch square drive and said housing having a depth of less than 12 mm.

17. A ratchet wrench comprising:
a handle having opposing ends, a first said end connected with a housing, said housing having a switch recess and an inner surface defining a housing aperture, said inner surface having a plurality of housing ramps;
a clutch ring having a first and second ends each having an actuator face, said clutch ring having an outer surface and an inner surface that defines an aperture, said outer surface having a plurality of transmission ramps, at least a portion of said inner surface having a plurality of clutch teeth, and at least a portion of said inner surface being smooth;
a switch situated within said switch recess, said switch having an actuator situated between said actuation faces of said clutch ring, and at least one biasing protrusion;
a drive element having an outer surface and an inner surface defining a drive aperture, said outer surface comprising a plurality of drive teeth, said inner surface comprising a drive engaging member, said drive element being situated within said clutch ring, and said clutch ring being situated within said housing aperture.

18. A ratchet wrench comprising:
a handle having opposing ends, said first end connected with a housing, said housing having a switch recess and an inner surface defining a housing aperture, said inner surface having a plurality of housing ramps;
a clutch ring having a first end and second end each having an actuator face, said clutch ring having an outer surface and an inner surface defining an aperture, said outer surface having a plurality of transmission ramps, and at least a portion of said inner surface being smooth;
a switch situated within said switch recess, said switch having an actuator situated between said actuation faces of said clutch ring, and at least one biasing protrusion;
a drive element having an outer surface and an inner surface that defines a drive aperture, said inner surface comprising a drive engaging member, said drive element being situated within said clutch ring, and said clutch ring being situated within said housing aperture.

19. A ratchet wrench as claimed in claim 18, wherein said drive aperture is configured directly engage fasteners.
